(19) United States
(12) Patent Application Publication
(10) Pub. No.: US 2023/0137261 A1
(43) Pub. Date: May 4, 2023

(54) MICROELECTRO-OPTICAL BEAM-GUIDANCE DEVICE AND SMART GLASSES HAVING THE MICROELECTRO-OPTICAL BEAM-GUIDANCE DEVICE

(71) Applicant: Robert Bosch GmbH, Stuttgart (DE)

(72) Inventor: Gael Pilard, Wankheim (DE)

(21) Appl. No.: 18/047,864

(22) Filed: Oct. 19, 2022

(30) Foreign Application Priority Data
Nov. 2, 2021 (DE) 10 2021 212 343.0

(51) Int. Cl. G02B 26/08; G02B 27/01

(52) U.S. Cl. CPC G02B 26/085; G02B 27/0172; G02B 2027/0178

(57) ABSTRACT

A microelectro-optical beam-guidance device. The device includes an optical damping element that includes an optical filter and beam-guidance surfaces. The optical filter is provided to reduce an intensity of a light beam when passing through the optical damping element. The beam-guidance surfaces are being disposed and/or formed in such a way that an intended entry vector of a light beam into the optical damping element and an intended exit vector of the light beam out of the optical damping element are offset relative to each other as viewed along the intended entry vector. The beam-guidance surfaces and the optical filter are disposed and/or formed in such a way that portions of a light beam reflected at the optical filter within the optical damping element have a reflection vector upon exiting the optical damping element which is different from a vector antiparallel to the intended entry vector.

### CROSS REFERENCE

The present application claims the benefit under 35 U.S.C. § 119 of German Patent Application No. DE 10 2021 212 343.0 filed on Nov. 2, 2021, which is expressly incorporated herein by reference in its entirety.

### BACKGROUND INFORMATION

A microelectro-optical beam-guidance device has already been proposed, having at least one optical damping element that includes at least one optical filter and at least two beam-guidance surfaces, the optical filter being provided to reduce an intensity of a light beam when passing through the optical damping element, the at least two beam-guidance surfaces being disposed and/or formed in such a way that an intended entry vector of a light beam into the optical damping element and an intended exit vector of the light beam out of the optical damping element are offset relative to each other as viewed along the intended entry vector.

### SUMMARY

The present invention is based on a microelectro-optical beam-guidance device having at least one optical damping element that includes at least one optical filter and at least two beam-guidance surfaces, the optical filter being provided to reduce—especially independently of the wavelength—an intensity of a light beam, particularly a laser beam, when passing through the optical damping element, the at least two beam-guidance surfaces being disposed and/or formed in such a way that an intended entry vector of a light beam, particularly a laser beam, into the optical damping element and an intended exit vector of the light beam, particularly a laser beam, out of the optical damping element are offset relative to each other as viewed along the intended entry vector.

According to an example embodiment of the present invention, it is provided that the at least two beam-guidance surfaces and the optical filter be disposed and/or formed in such a way that portions of a light beam reflected at the optical filter within the optical damping element have a reflection vector upon exiting the optical damping element which is different from a vector antiparallel to the intended entry vector. Preferably, a propagation direction of at least a large portion of light beams reflected at the optical filter and exiting from the optical damping element extends parallel to the reflection vector. By preference, a propagation direction of light beams from a source of radiation, particularly a light source, preferably a laser source, and striking the optical damping element extends parallel to the entry vector and to the vector antiparallel to the intended entry vector. Preferably, the reflection vector and the vector antiparallel to the intended entry vector span an angle which in particular is greater than 5°, preferably greater than 8° and especially preferred, greater than 10°. The beam-guidance device, particularly the optical damping element, is provided preferably for an optical guidance of laser light or laser beams. Especially preferred, in at least one directional component, the reflection vector is formed differently from the vector antiparallel to the intended entry vector. Preferably, the at least two beam-guidance surfaces and the optical filter are placed one after the other along an intended beam path through the optical damping element. The intended beam path is to be understood specifically as a section on which a/the light beam moves through the optical damping element during an envisaged use of the beam-guidance device, particularly in view of a placement of the optical damping element in the case of this usage. The optical damping element, especially the at least two beam-guidance surfaces and the optical filter, is/are formed preferably in one piece. In particular, each of the at least two beam-guidance surfaces takes the form of an inner surface or outer surface of a base body of the optical damping element. Preferably, the optical filter is disposed, especially directly, on the/a base body of the optical damping element. Preferably, the base body/bodies of the optical damping element and the optical filter are placed fixedly together. It is possible for the/a base body of the optical damping element to form the optical filter, in particular the at least two beam-guidance surfaces and/or the base body/bodies of the optical damping element being formed integrally with the optical filter. “Integrally” is to be understood specifically as formed in one piece. This one piece is produced preferably from a single blank, a mass and/or a casting.

According to an example embodiment of the present invention, the optical filter is provided preferably to selectively reduce an intensity of a light beam passing through the optical damping element, especially the optical filter, or a light beam reflected at the optical filter. A “selective reduction” is to be understood preferably as a reduction by a portion especially of the intensity of a light beam, the portion being predetermined particularly by optical or material properties of the optical filter. It is possible for the light beams to include one or more than one color, particularly radiation having one or more than one wavelength range assignable to a color. In particular, the optical filter is provided to damp the light beams independently of the wavelength, that is, to reduce their intensity wavelength-independently. Alternatively, it is possible for the optical filter to be formed in such a way that the intensity of the light beams traversing the optical damping element is reduced in all wavelength ranges included in the light beams. In one preferred embodiment, the optical filter takes the form of a neutral filter, preferably a neutral density filter. By preference, the base body/bodies of the optical damping element is/are formed at least for the most part—preferably along the intended beam path—of a material that optically is at least essentially completely transparent for the light beams, particularly the laser beams. The base body/bodies of the optical damping element is/are formed preferably of a glass. In particular, the base body/bodies of the optical damping element is/are formed of a material which has a refractive index of not more than 1.6, preferably not more than 1.54 and especially preferred, not more than 1.53. The at least two beam-guidance surfaces are formed preferably as reflecting surfaces. The at least two beam-guidance surfaces are provided preferably to at least mostly reflect a light beam moving along the intended beam path, especially preferably within the optical damping element, particularly within one of the base bodies/the base body of the optical damping element.

According to an example embodiment of the present invention, preferably, the at least two beam-guidance surfaces and the optical filter are disposed and/or formed in such a way that at least a greater part of components of a light beam, especially a laser beam, propagating via the intended beam path through the optical damping element and reflected at the optical filter, upon exiting from the optical damping element, move along the reflection vector and/or have the reflection vector. In particular, light beams, especially laser beams, propagating along the intended beam path, upon entering into the optical damping element, move along the intended entry vector and/or have the intended entry vector. In particular, light beams, especially laser beams, propagating along the intended beam path, upon exiting from the optical damping element, move along the intended exit vector and/or have the intended exit vector.

According to an example embodiment of the present invention, the microelectro-optical beam-guidance device, especially the optical damping element, is provided for use in or with a microelectro-optical system, particularly smart glasses. Smart glasses are provided specifically to output information optically directly to a user, preferably to an eye of the user, especially independently of a visual display or the like. It is possible that an output of information through the smart glasses is controllable with the aid of a viewing direction, a voice command or the like of the user. Smart glasses are established in a large number of fields of application, e.g., in military applications, in the gaming sector, etc. Low-cost and compact designs are especially advantageous in this context. In the case of smart glasses, the safety of the user is also especially important. Namely, many smart glasses use laser light for the output of information to an eye of the user. An intensity of light, particularly laser light, striking the eye must be regulated and/or reduced appropriately in order to avoid injuring the eye, especially since customary laser sources have more power than is needed for an output to the eye, especially via the smart glasses. Furthermore, for the area of application in smart glasses, in particular only very low tolerances are possible in the design of the optical damping element.

The optical damping element preferably has a maximum main extension of not more than 2 cm, preferably not more than 1 cm, and especially preferred, not more than 0.3 cm. The microelectro-optical beam-guidance device, especially the optical damping element, is provided preferably to deflect and simultaneously to attenuate or damp light beams, particularly laser beams, incoming especially via the intended entry vector. In particular, the microelectro-optical beam-guidance device, especially the optical damping element, is provided for a directed deflection of light beams, the optical damping element specifically having a maximum tolerance of less than 1° for the intended exit vector. The microelectro-optical beam-guidance device is provided preferably to guide light beams along a guidance section, which specifically includes the beam path, from an entry point of the beam-guidance device to an exit point of the beam-guidance device.

The design of the microelectro-optical beam-guidance device according to the present invention makes it possible to advantageously prevent damage to beam-guidance components and/or a beam source due to backscattered portions of light beams. An interaction of reflected portions of the light beams with incoming light beams may advantageously be prevented. At the same time, unwanted exposure of a sensitive object, e.g., an eye of a user, due to unattenuated light may advantageously be prevented by the optical damping element. In particular, a continuous generation of light may be disturbed or other optical components which are situated in front of the light source may be damaged in response to a reflection of light beams into a light source, especially in the case of laser light.

In addition, according to an example embodiment of the present invention, it is provided that the at least two beam-guidance surfaces in each case be at least essentially flat and be aligned at least essentially parallel to one another. Advantageously great flexibility of the optical damping element in terms of an alignment about an axis of rotation of the optical damping element may be made possible, without influencing an entry angle and exit angle of light beams out of the optical damping element. This advantageously allows additional tolerance with respect to a placement of the optical damping element. To be understood by “essentially flat” is, in particular, a form of a surface, especially the at least two beam-guidance surfaces, where each point within the surface has a minimum distance of not more than 0.2 μm, preferably not more than 0.1 μm, and especially preferred, not more than 0.01 μm to a main extension plane of the surface. A “main extension plane” of a component, especially one of the at least two beam-guidance surfaces, is to be understood particularly as a plane that is parallel to a largest side face of a smallest imaginary cuboid which just barely completely encompasses the component, and especially runs through the midpoint of the cuboid. “Essentially parallel” is to be understood particularly as an alignment of a straight line, a plane or a direction, especially of one of the at least two beam-guidance surfaces, relative to another straight line, another plane or a reference direction, especially of another of the at least two beam-guidance surfaces, the straight line, the plane or the direction having a deviation of less than 8°, advantageously less than 5°, and especially preferred, less than 2° relative to the other straight line, the other plane or the reference direction. The at least two beam-guidance surfaces are provided preferably to at least partially, preferably at least mostly, reflect light beams impinging on the respective beam-guidance surface, preferably within the optical damping element, especially a base body of the optical damping element. In particular, the intended beam path touches the at least two beam-guidance surfaces. In particular, in each case the intended beam path has a kink at the at least two beam-guidance surfaces. Preferably, each of the at least two beam-guidance surfaces is set apart from an intended entry point of the optical damping element and from an intended exit point of the optical damping element. The intended entry point is to be understood specifically as an area of the optical damping element via which light beams to be guided or to be damped enter into the optical damping element, particularly via the intended entry vector, during an envisaged use of the beam-guidance device, particularly in view of a placement of the optical damping element in the case of this use. The intended exit point is to be understood specifically as an area of the optical damping element via which light beams to be guided or to be damped exit from the optical damping element, particularly via the intended exit vector, preferably after passing through the intended beam path, during an envisaged use of the beam-guidance device, particularly in view of a placement of the optical damping element in the case of this use. In one preferred embodiment, the optical damping element includes exactly two beam-guidance surfaces. However, it is also possible for the optical damping element to have more than two beam-guidance surfaces. The optical filter preferably includes two transmission surfaces which are to be made at least partially transparent for light beams, particularly laser beams, to be guided through the beam-guidance device. Preferably, the intended beam path extends through the transmission surfaces. It is possible that light beams, particularly along the intended beam path, are at least partially deflected, especially reflected, at the transmission surfaces of the optical filter. In particular, the transmission surfaces are formed separately from the beam-guidance surfaces. In one alternative design, it is possible for the optical filter and at least one of the beam-guidance surfaces to be formed in one piece, light beams in particular being reflected at least partially, especially at least mostly, at the beam-guidance surface and at the same time being damped and/or an intensity of the light beams being reduced. It is also possible for the at least two beam-guidance surfaces to be formed obliquely relative to each other. Especially preferred, the optical damping element includes an even number of beam-guidance surfaces.

In addition, according to an example embodiment of the preset invention, it is provided that a light beam passing through the optical damping element on a beam path, especially the intended beam path previously indicated, have a propagation vector at one point of a surface of the optical filter at which the light beam strikes the optical filter, especially at one of the transmission surfaces, the optical filter and/or the at least two beam-guidance surfaces being disposed and/or formed in such a way that the propagation vector is inclined relative to a surface normal of the surface of the optical filter. An advantageously simple deflection of reflected portions of the light beam relative to incoming light beams may be achieved. This permits a reflection vector different from the vector antiparallel to the intended entry vector in an advantageously simple manner. In particular, the propagation vector extends along an imaginary straight line which includes a main propagation direction of the light beam striking the optical filter. Specifically, the propagation vector has a direction which corresponds to the main propagation direction of the light beam striking the optical filter. Preferably, the propagation vector, inclined particularly relative to the surface normal of the surface of the optical filter, and/or the main propagation direction of the light beam striking the optical filter spans an angle other than 0° and 180°, preferably an angle between 5° and 175°, with the surface normal of the surface of the optical filter. The transmission surfaces and/or the surface of the optical filter are in each case preferably at least essentially flat. Preferably, the surface normal of the surface of the optical filter is aligned at least essentially parallel to a central axis and/or a thickness of the optical filter. In particular, the optical filter has a further surface or one of the transmission surfaces, through which light beams exit from the optical filter and which specifically is at least essentially flat. The thickness of the optical filter is formed particularly as a minimal distance between the surface and the further surface of the optical filter and/or between the two transmission surfaces of the optical filter. Preferably, the surface and the further surface of the optical filter and/or the two transmission surfaces of the optical filter are formed at least essentially parallel to one another.

In addition, according to an example embodiment of the present invention, it is provided that the at least two beam-guidance surfaces and the optical filter be disposed and/or formed in such a way that the intended entry vector and the intended exit vector are formed at least essentially parallel to one another. An advantageously flexible design or placement of the optical damping element may be made possible for a predetermined fixed placement of the exit vector relative to the entry vector. Preferably the intended entry vector and the intended exit vector are set apart from each other as viewed along the intended entry vector.

Furthermore, according to an example embodiment of the present invention, it is provided that the optical filter have at least one surface, especially the previously indicated surface and/or one of the previously indicated transmission surfaces, which is inclined about two, especially imaginary, axes relative to at least one beam-guidance surface of the at least two beam-guidance surfaces, especially relative to the two beam-guidance surfaces aligned at least essentially parallel to one another. Portions of the light beams reflected at the optical filter may be conducted in advantageously simple manner out of the optical damping element via an outer surface of the optical damping element disposed separately from the beam-guidance surfaces. This advantageously allows great flexibility in terms of an exit direction of reflected portions of the light beams. A detection unit for detecting reflected portions of the light beams may be disposed in advantageously flexible manner in a configuration relative to the optical damping element. In particular, the surface is inclined about the two, especially imaginary, axes, aligned perpendicular to one another, relative to at least one beam-guidance surface of the at least two beam-guidance surfaces, especially relative to the two beam-guidance surfaces aligned at least essentially parallel to one another. Preferably the surface of the optical filter, in particular inclined about the two axes relative to the beam-guidance surface(s), spans an angle other than 0° and 90°, preferably an angle between 5° and 85°, with at least one of the two, especially imaginary, axes. An “inclined arrangement” of a straight line or a plane, especially a plane including the surface of the optical filter, relative to another straight line or another plane, especially a straight line including one of the two axes, is to be understood particularly as an alignment of the straight line or of the plane, differing from a parallel and perpendicular arrangement, relative to the other straight line or the other plane. Alternatively, it is possible for the surface of the optical filter to be inclined about only one, especially imaginary, axis relative to at least one beam-guidance surface of the at least two beam-guidance surfaces, especially relative to the two beam-guidance surfaces aligned at least essentially parallel to one another. Preferably, the surface of the optical filter is formed and/or disposed in such a way that the two, especially imaginary, axes are aligned specifically at least essentially perpendicular to one another and intersect preferably at one point. In one preferred embodiment, the surface of the optical filter is formed and/or disposed in such a way that the two, especially imaginary, axes are in each case aligned at least essentially perpendicular to the intended beam path through the optical damping element, particularly the optical filter. “Essentially perpendicular” is to be understood particularly as an alignment of a straight line, a plane or a direction, especially a straight line including one of the two axes, relative to another straight line, another plane or a reference direction, particularly a straight line including the beam path in a section of the beam path or a plane including the beam path, where the straight line, the plane or the direction and the other straight line, the other plane or the reference direction span an angle of 90° with a maximum deviation of particularly less than 8°, advantageously less than 5° and especially advantageously, less than 2°, as viewed particularly in a projection plane.

In addition, according to an example embodiment of the present invention, it is provided that the optical filter be disposed at least partially between the at least two beam-guidance surfaces as viewed along a beam path, especially the intended beam path previously indicated, for a light beam through the optical damping element. A deviation of the reflection vector relative to the vector antiparallel to the intended entry vector may be achieved advantageously via an alignment of the optical filter, notably regardless of a design of the beam-guidance surfaces. It is possible to achieve an advantageously stable and protected placement of the optical filter. The optical filter is formed or disposed preferably within a base body of the optical damping element or between two base bodies of the optical damping element. Preferably, the intended beam path extends, particularly in a section of the intended beam path, from one of the at least two beam-guidance surfaces through the optical filter to another of the at least two beam-guidance surfaces.

According to an example embodiment of the present invention, it is further provided that the optical filter be disposed at least partially on at least one of the least two beam-guidance surfaces. The optical damping element may be produced in an advantageously simple and cost-effective manner, especially since the optical filter may be applied on an outer side of a base body. The optical filter and the beam-guidance surface of the at least two beam-guidance surfaces are formed preferably in one piece, in particular light beams being damped and/or an intensity of the light beams being reduced on the occasion of an at least partial reflection at the beam-guidance surface. By preference, the other beam-guidance surface, set apart especially from the optical filter, is aligned at least essentially parallel to the beam-guidance surface specifically forming or having the optical filter. It is possible for the intended beam path to extend at least partially into the optical filter, preferably in front of a kink which is assigned to a reflection of light beams at the beam-guidance surface. Alternatively, it is possible for a surface of the optical filter facing the base body/one of the base bodies of the optical damping element to be formed in one piece with the beam-guidance surface, in particular, the intended beam path touching the optical filter only at the surface. Alternatively or additionally, it is possible that a/the optical filter be disposed and/or formed on a second beam-guidance surface of the at least two beam-guidance surfaces. Alternatively or additionally, it is possible for a/the optical filter to be disposed and/or formed on an entry surface or an exit surface of the optical damping element, especially for a light beam propagating along the intended beam path.

Moreover, according to an example embodiment of the present invention, it is provided that the at least two beam-guidance surfaces and the optical filter be disposed and/or formed in such a way that the reflection vector and a vector antiparallel to the intended entry vector span an angle of at least 20°, preferably at least 30° and, especially preferred, at least 40°. Inadvertent damage to the radiating source or other optical beam-guidance elements upstream of the optical damping element may advantageously be prevented. Interferences of reflected portions of the light beams and incoming light beams may advantageously be prevented.

In addition, according to an example embodiment of the present invention, it is provided that the microelectro-optical beam-guidance device include at least one detection unit for detecting a portion of a light beam reflected within the optical damping element, particularly at the optical filter. This permits advantageously simple monitoring of a performance of the optical damping element, preferably without an interaction with light beams damped or to be damped. An advantageously high quality of light beams to be produced via the optical damping element may thus be realized. The detection unit is disposed preferably on an outer surface of the optical damping element or set apart from the optical damping element. In particular, the detection unit is equipped to detect the portion of light beams in an area around the optical damping element that is propagating specifically along the intended beam path and reflected within the optical damping element, particularly at the optical filter, at inner surfaces of a base body of the optical damping element and/or at one of the beam-guidance surfaces or at the beam-guidance surfaces. The detection unit preferably includes at least one sensor element which, e.g., takes the form of a photodiode, a CMOS sensor, a camera or the like. The detection unit is furnished preferably to monitor a performance of the optical damping element as a function of the detection of the reflected portion of the light beam guided through the optical damping element. In particular, the detection unit is equipped to identify an absence of a reflected portion of the light beam, especially upon or after emission of a light beam through the optical damping element. The detection unit is equipped especially to detect a malfunction and/or damage of the optical damping element if, upon or after emission of a light beam through the optical damping element, an absence of a reflected portion of the light beam is identified. Alternatively or additionally, it is possible for the beam-guidance device to include an absorption unit which is provided for the absorption of light reflected within and/or at the optical damping element, especially at the optical filter. The absorption unit preferably includes at least one absorption element which is disposed at or set apart from the optical damping element. Alternatively or additionally, it is possible that an absorption element of the absorption unit be formed in one piece with the optical damping element, e.g., as a coated outer surface of a base body of the optical damping element or the like. The absorption unit is provided preferably to essentially prevent propagation of light, reflected within or at the optical damping element, into an area surrounding the beam-guidance device in at least one direction.

In addition, according to an example embodiment of the present invention, smart glasses are provided having at least one microelectro-optical beam-guidance device according to the present invention. The smart glasses may take the form of monocular smart glasses or binocular smart glasses. “Monocular smart glasses” are to be understood preferably as smart glasses which are provided in order, in at least one operating state, to add an optical, especially virtual representation to a field of view of the user, and which have a projection unit specifically for one eye of the user which presents at least a partial image of the optical representation to the one eye. “Binocular smart glasses” are to be understood preferably as smart glasses which are provided in order, in at least one operating state, to add an optical, especially virtual representation to a field of view of the user, and which in each case have a projection unit specifically for two eyes of the user which presents at least a partial image of the optical representation to each of the two eyes. Preferably, the smart glasses have a, preferably binocular, oculography system which is designed specifically to measure the at least one viewing parameter. The smart glasses preferably have at least one arithmetic logic unit which is designed particularly to store and/or to process measured parameters. Preferably, all partial images are projected into one eye each. Each partial image preferably forms at least one section of an image of the representation. In particular, one partial image may completely form one image of the representation. Notably, each image of the representation may be formed by more than two, especially more than ten, particularly more than one hundred, especially more than one thousand, namely unlimited, especially mathematically infinitesimally small partial images. By preference, in binocular smart glasses, all partial images are generated in pairs, each pair of partial images being projected into a different eye of the user. In binocular smart glasses, preferably all partial images, in each case at least in pairs, form at least one section of an image, particularly an image of the representation, specifically on the basis of an interpretation by a brain of the user. The partial images, which together form, especially generate, an image of the representation, may show the same motif and/or a modified motif to evoke a 3-D effect. An “image” is to be understood generally as visual information perceptible by an eye, which, for example, may be formed partially or completely as a specifically non-pictorial text representation and/or particularly a number representation. Preferably, a “viewing parameter” is to be understood as a parameter from which a viewing angle and/or a viewing depth, particularly a viewing distance, of a user from a viewed object may be determined, especially calculated, such as, for example, a viewing direction, especially an alignment of pupils in relation to eyes, particularly to eyelids, the caruncula lacrimalis and the lateral and medial canthus, of the user, an accommodation parameter such as a form of a lens of an eye, a focal length of the lens, a distance of the lens from a retina of the eye and/or a distance of the lens from a cornea of the eye. In particular, the viewing parameter may be determined via visible and/or infrared light by the oculography system of the smart glasses. In particular, the viewing parameter may take the form of a viewing-angle parameter or viewing-depth parameter. In at least one method step, especially the continuous-operation step, preferably a viewing direction of each eye of the user is determined as the at least one viewing parameter of the user of the smart glasses, particularly by a binocular oculography system of the smart glasses, especially by a binocular camera unit, a binocular laser feedback interferometry unit and/or a scanned laser-photo oculography of the oculography system of the smart glasses. In at least one method step, particularly the continuous-operation step, preferably a viewing crossing point is determined from the at least one viewing parameter, particularly by the at least one arithmetic logic unit of the smart glasses. The projection unit includes the at least one light source, preferably a laser source, which is provided to generate images through light beams, particularly laser beams. The light source, by preference laser source, preferably includes a plurality of laser diodes. By preference, the projection unit includes further optical components, preferably for the collimation of bundles of rays generated via the light source, the bundles of rays being provided in particular for combining as light beam and/or for traversing the optical damping element. In particular, the projection unit includes a plurality of optical combiners which are provided to combine the bundles of rays generated via the light source. The projection unit preferably includes the microelectro-optical beam-guidance device, particularly the optical damping element. It is possible for the beam-guidance device to include a plurality of optical damping elements, which notably, at least for the most part are structurally identical. In particular, as viewed from the light source along a propagation direction of a bundle of rays generated in the light source, the beam-guidance device is disposed downstream of the further optical components, particularly collimators, and/or the optical combiners.

Advantageously good quality of optical elements to be displayed may be realized utilizing the design of the smart glasses according to the present invention. Advantageously long surface life of the smart glasses may be achieved. Advantageously low assembly and maintenance costs may be made possible. In particular, in the event the optical filter of the optical damping element of the microelectro-optical beam-guidance device is damaged or destroyed, light beams may advantageously be prevented from scattering into an eye of a user.

The microelectro-optical beam-guidance device of the present invention and/or the smart glasses of the present invention is/are not intended to be limited to the usage and specific embodiment described above. In particular, the microelectro-optical beam-guidance device of the present invention and/or the smart glasses of the present invention may have a number of individual elements, components and units differing from the number indicated herein for fulfilling a mode of operation described herein. In addition, in the case of the value ranges indicated in this disclosure, values lying within the indicated limits are also to be regarded as disclosed and usable as desired.

### BRIEF DESCRIPTION OF THE DRAWINGS

Further advantages are derived from the following description of the figures. Three exemplary embodiments of the present invention are shown in the figures. The figures and the description contain numerous features in combination. One skilled in the art will expediently consider the features individually, as well, and combine them to form further useful combinations.

FIG. 1 shows a schematic view of smart glasses according to the present invention having a microelectro-optical beam-guidance device according to the present invention.

FIG. 2 shows a schematic diagram of an image output of the smart glasses according to the present invention via the microelectro-optical beam-guidance device according to the present invention.

FIG. 3 shows a schematic representation of an exemplary beam path through an optical damping element of the microelectro-optical beam-guidance device according to the present invention.

FIG. 4 shows a schematic representation of an alternative alignment of the optical damping element of the microelectro-optical beam-guidance device according to the present invention.

FIG. 5 shows a schematic representation of an optical damping element of an alternative design of a microelectro-optical beam-guidance device according to the present invention, having an optical filter disposed on an outer surface of the optical damping element.

FIG. 6 shows a schematic representation of an optical damping element of a further alternative design of a microelectro-optical beam-guidance device according to the present invention, having an optical filter rotated about two axes relative to beam-guidance surfaces of the optical damping element.

### DETAILED DESCRIPTION OF EXAMPLE EMBODIMENTS

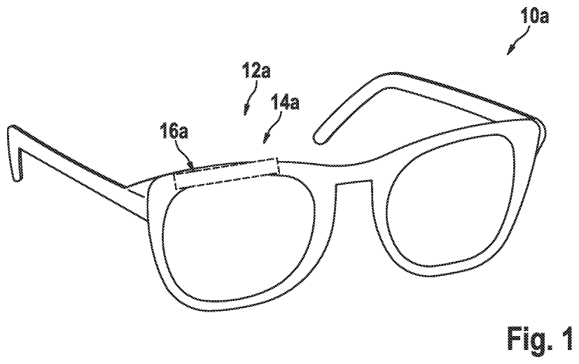

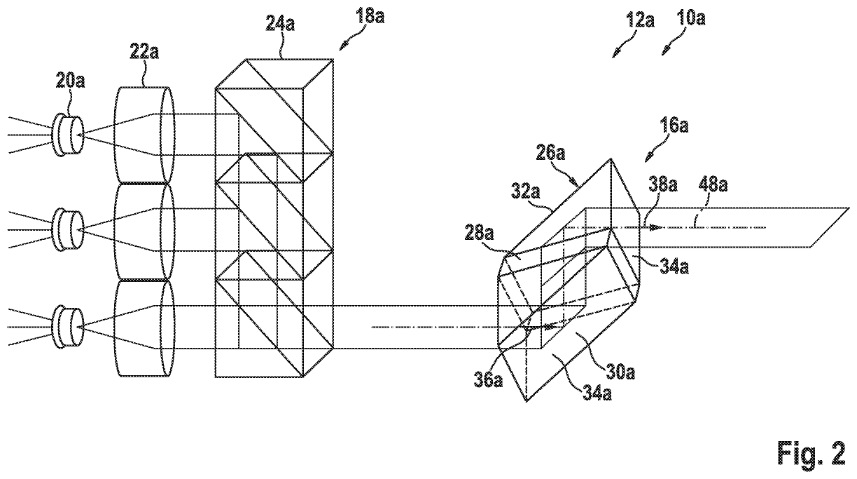

FIG. 1 shows smart glasses 10a in the form of monocular smart glasses. Smart glasses 10a include a projection unit 12a and an oculography system 14a. Smart glasses 10a, particularly projection unit 12a, include a microelectro-optical beam-guidance device 16a which is provided to guide laser beams generated by a laser source 18a of projection unit 12a (see FIG. 2). Microelectro-optical beam-guidance device 16a is provided to guide the laser beams, generated by laser source 18a, in the direction of an eye of a user of smart glasses 10a.

Other designs of smart glasses 10a are also possible. In addition, forms of microelectro-optical beam-guidance device 16a in/as part of other devices or the like that differ from smart glasses 10a are possible, as well.

FIG. 2 shows a schematic diagram of an image output of smart glasses 10a, particularly of projection unit 12a, via microelectro-optical beam-guidance device 16a. Three laser diodes 20a of laser source 18a, three collimators 22a as well as an optical combiner 24a of projection unit 12a are shown by way of example in FIG. 2. In particular, projection unit 12a includes a plurality of laser diodes 20a, collimators 22a and optical combiners 24a. Microelectro-optical beam-guidance device 16a includes a plurality of optical damping elements 26a, only one of optical damping elements 26a being shown specifically by way of example in FIG. 2. Features of optical damping elements 26a of beam-guidance device 16a are described hereinafter on the basis of optical damping element 26a shown.

Optical damping element 26a includes an optical filter 28a and two beam-guidance surfaces 30a, 32a. Optical filter 28a is provided to reduce an intensity of a laser beam, independently of wavelength, when passing through optical damping element 26a. Optical damping element 26a includes two base bodies 34a, optical filter 28a being disposed between the two base bodies 34a. In particular, the two base bodies 34a of optical damping element 26a are of essentially identical construction. Base bodies 34a are formed particularly of glass and specifically are passable at least essentially without loss for laser beams of laser source 18a. Each of the two base bodies 34a of optical damping element 26a has a triangular base. Each of the two base bodies 34a is formed as a prism. Each of the two base bodies 34a of optical damping element 26a has one of the two beam-guidance surfaces 30a, 32a. Optical filter 28a is formed as a layer between the two base bodies 34a. Optical filter 28a is at least essentially plate-shaped. Other forms of optical damping element 26a, particularly of base bodies 34a, beam-guidance surfaces 30a, 32a and/or optical filter 28a are possible, as well. For example, forms of optical damping element 26a with only one base body 34a or more than two base bodies 34a, with more than one optical filter 28a and/or with a different design and/or placement of optical filter 28a are possible. Alternatively or additionally, designs of optical damping element 26a with more than two beam-guidance surfaces 30a, 32a are possible. Especially preferred, the two beam-guidance surfaces 30a, 32a are formed as reflecting surfaces and are provided to reflect laser beams at least for the most part, particularly essentially completely, especially preferred, under total reflection. Alternatively or additionally, optical damping element 26a is possibly formed in one piece, optical damping element 26a having a base body 34a which forms beam-guidance surfaces 30a, 32a and—particularly between two sections of base body 34a—optical filter 28a. Base bodies 34a, particularly a material of base bodies 34a, are formed preferably in such a way that a minimal angle to the total reflection at an inner surface of base body/bodies 34a amounts to at least 45°, preferably at least 42°, and especially preferred, at least 40°.

Each of the three laser diodes 20a is provided to generate laser light having a different wavelength, particularly in the colors red, green and blue. The laser light generated via laser diodes 20a is directed via collimators 22a. Optical combiner 24a is provided to combine the laser beams of laser diodes 20a, the three laser beams generated specifically having one common beam path. Beam-guidance device 16a, particularly optical damping element 26a, is provided to deflect the combined laser beam and to reduce an intensity of the combined laser beam, preferably for a projection of the laser beam onto a lens or a holographic optical element (not shown in figures), especially as part of smart glasses, for imaging onto an eye of a user of smart glasses 10a, or directly onto an eye of a user of smart glasses 10a. Beam-guidance device 16a, particularly optical damping element 26a, is provided preferably for optical guidance of laser light or laser beams of laser source 18a, especially of electromagnetic radiation having a wavelength which corresponds to a wavelength of laser light able to be generated via laser source 18a. Optical filter 28a is provided to selectively and wavelength-independently reduce the intensity of a laser beam passing through optical damping element 26a, particularly optical filter 28a. Optical filter 28a is in the form of a neutral-density filter.

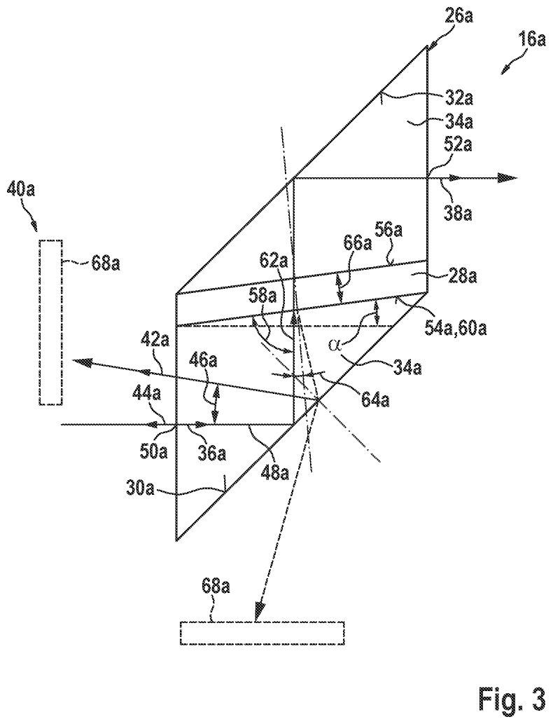

The two beam-guidance surfaces 30a, 32a are disposed and/or formed in such a way that an intended entry vector 36a of a laser beam into optical damping element 26a and an intended exit vector 38a of the laser beam out of optical damping element 26a are offset relative to each other as viewed along intended entry vector 36a. The two beam-guidance surfaces 30a, 32a and optical filter 28a are disposed one after the other along an intended beam path 48a through optical damping element 26a. Optical damping element 26a, especially base bodies 34a, the two beam-guidance surfaces 30a, 32a and optical filter 28a are formed in one piece. In particular, each of the two beam-guidance surfaces 30a, 32a is formed as an inner surface of one of the two base bodies 34a of optical damping element 26a. Optical filter 28a is disposed directly on the two base bodies 34a of optical damping element 26a. The two base bodies 34a of optical damping element 26a and optical filter 28a are placed firmly together. Alternatively, it is possible for at least one of the base bodies/a base body 34a of optical damping element 26a to form optical filter 28a. Beam-guidance device 16a includes a detection unit 40a for detecting a portion of a laser beam reflected within optical damping element 16a, particularly at optical filter 28a (see FIG. 3).

FIG. 3 shows a detailed side view of optical damping element 26a with an exemplary beam path of a laser beam. The two beam-guidance surfaces 30a, 32a and optical filter 28a are disposed and/or formed in such a way that portions of a light beam reflected at optical filter 28a within optical damping element 26a have a reflection vector 42a upon exiting optical damping element 26a which is different from a vector 44a antiparallel to intended entry vector 36a. Especially preferred, in at least one directional component, reflection vector 42a is formed differently from vector 44a antiparallel to intended entry vector 36a. In particular, a propagation direction of at least a large portion of light beams reflected at optical filter 28a and exiting from optical damping element 26a is aligned parallel to reflection vector 42a. Preferably, a propagation direction of light beams generated in laser source 18a and striking optical damping element 26a extends parallel to entry vector 36a and to vector 44a antiparallel to intended entry vector 36a. Reflection vector 42a and vector 44a antiparallel to intended entry vector 36a preferably span an angle 46a which in particular is greater than 5°, preferably greater than 8° and especially preferred, greater than 10°. The two beam-guidance surfaces 30a, 32a and optical filter 28a are disposed and/or formed in such a way that angle 46a between reflection vector 42a and vector 44a antiparallel to intended entry vector 36a amounts to at least 20°. In particular, angle 46a spanned by reflection vector 42a and vector 44a antiparallel to intended entry vector 36a amounts to at least essentially 25°. However, other designs of optical damping element 26a, particularly of beam-guidance surfaces 30a, 32a and optical filter 28a are also possible, in which, for example, reflection vector 42a spans an angle 46a of greater than 25° with vector 44a antiparallel to intended entry vector 36a.

The two beam-guidance surfaces 30a, 32a are each at least essentially flat and are aligned at least essentially parallel to one another. Each of the two beam-guidance surfaces 30a, 32a is provided to at least mostly, especially at least completely, reflect light beams striking respective beam-guidance surface 30a, 32a along intended beam path 48a, preferably within optical damping element 26a, particularly one of base bodies 34a of optical damping element 26a. Intended beam path 48a in each case has a kink at the two beam-guidance surfaces 30a, 32a. Each of the two beam-guidance surfaces 30a, 32a is set apart from an intended entry point 50a of optical damping element 26a and from an intended exit point 52a of optical damping element 26a.

Optical filter 28a includes two transmission surfaces 54a, 56a which are at least partially transmitting for laser beams to be guided through beam-guidance device 16a. Preferably, intended beam path 48a extends through the two transmission surfaces 54a, 56a, particularly at an angle 58a between 30° and 85°, preferably between 45° and 85° and, especially preferred, between 60° and 85°. Specifically, laser beams propagating along intended beam path 48a are at least partially reflected at transmission surfaces 54a, 56a of optical filter 28a. Transmission surfaces 54a, 56a of optical filter 28a are formed separately from the two beam-guidance surfaces 30a, 32a.

A laser beam passing through optical damping element 26a on an intended beam path 48a has a propagation vector 62a at one point of a surface 60a of optical filter 28a, which preferably is formed as a first transmission surface 54a of transmission surfaces 54a, 56a and at which the laser beam strikes optical filter 28a, optical filter 28a and the two beam-guidance surfaces 30a, 32a being disposed and/or formed in such a way that propagation vector 62a is inclined relative to a surface normal of surface 60a of optical filter 28a. Propagation vector 62a extends along an imaginary straight line which includes a main propagation direction of a laser beam propagating along intended beam path 48a and striking optical filter 28a. In particular, propagation vector 62a has a direction which corresponds to the main propagation direction of the light beam striking optical filter 28a. Propagation vector 62a, in particular inclined relative to the surface normal of surface 60a of optical filter 28a, and/or the main propagation direction of the light beam striking optical filter 28a spans an angle 64a other than 0° and 180°, preferably an angle between 5° and 175°, with the surface normal of surface 60a of optical filter 28a. In particular, angle 64a between propagation vector 62a and/or the main propagation direction of the light beam striking optical filter 28a, and the surface normal of surface 60a of optical filter 28a amounts to essentially 5°. In particular, angle 64a between propagation vector 62a and/or the main propagation direction of the light beam striking optical filter 28a, and the surface normal of surface 60a of optical filter 28a corresponds to the angle between a plane aligned at 45° relative to first beam-guidance surface 30a and/or parallel to intended entry vector 36a, especially to angle α in FIG. 3. In particular, portions of the laser light propagating on intended beam path 48a and reflected at optical filter 28a, especially at surface 60a or first transmission surface 54a, are reflected in such a way that an angle with which the reflected portions again strike first beam-guidance surface 30a corresponds to double the angle 64a between propagation vector 62a and/or the main propagation direction of the light beam striking optical filter 28a, and the surface normal of surface 60a of optical filter 28a. Preferably, surface 60a is formed by one of transmission surfaces 54a, 56a of optical filter 28a. Transmission surfaces 54a, 56a, especially at least first transmission surface 54a, of optical filter 28a has an angle other than 45° relative to first beam-guidance surface 30a. Each of the two transmission surfaces 54a, 56a of optical filter 28a is at least essentially flat. The surface normal of surface 60a of optical filter 28a is aligned at least essentially parallel to a central axis and a thickness 66a of optical filter 28a. In particular, thickness 66a of optical filter 28a is formed as a minimal distance between the two transmission surfaces 54a, 56a of optical filter 28a. The two transmission surfaces 54a, 56a of optical filter 28a are formed at least essentially parallel to one another. The two beam-guidance surfaces 30a, 32a and optical filter 28a are disposed and/or formed in such a way that intended entry vector 36a and intended exit vector 38a are formed at least essentially parallel to one another. Preferably, optical damping element 26a is formed in such a way that the difference between an angle of incidence of the laser light propagating on the intended beam path and the first beam-guidance surface 30a, and double the angle 64a between propagation vector 62a and or the main propagation direction of the light beam striking optical filter 28a and the surface normal of surface 60a of optical filter 28a or the angle at which the portions reflected at optical filter 28a strike first beam-guidance surface 30a again, corresponds at the most to a minimum angle to the total reflection at an inner surface of base body 34a, which specifically is a function of the material of base body 34a.

Surface 60a of optical filter 28a is inclined about an imaginary axis relative to first beam-guidance surface 30a of the two beam-guidance surfaces 30a, 32a, the imaginary axis being aligned specifically at least essentially parallel to the two beam-guidance surfaces 30a, 32a and at least essentially perpendicular to a main guidance direction of intended beam path 48a through optical damping element 26a and/or to intended beam path 48a. Viewed along intended beam path 48a through optical damping element 26a, optical filter 28a is disposed at least partially between the at least two beam-guidance surfaces 30a, 32a. Optical filter 28a is formed or disposed between the two base bodies 34a of optical damping element 26a. In one section of intended beam path 48a, beam path 48a extends from one of the two beam-guidance surfaces 30a, 32a through optical filter 28a to another of the two beam-guidance surfaces 30a, 32a.

Detection unit 40a is positioned in such a way that laser light reflected within optical damping element 26a, particularly at optical filter 28a, at inner surfaces of base bodies 34a of optical damping element 26a and/or at the/one of beam-guidance surfaces 30a, 32a is detectable via detection unit 40a, specifically at least one sensor element 68a of detection unit 40a. Two possible placements of detection unit 40a, particularly of sensor element 68a, are shown by way of example in FIG. 3. Detection unit 40a, particularly sensor element 68a, is set apart from optical damping element 26a. Detection unit 40a is equipped to detect the portion of laser beams in an area around optical damping element 26a propagating particularly along intended beam path 48a and reflected within optical damping element 26a, especially at optical filter 28a, at one of the inner surfaces or at the inner surfaces of base bodies 34a and/or at one of the beam-guidance surfaces or at the beam-guidance surfaces 30a, 32a. Sensor element 68a takes the form of a photodiode. Other forms of detection unit 40a, particularly of sensor element 68a, are also possible, e.g., as a CMOS sensor, a camera or the like. Alternatively or additionally, it is possible for detection unit 40a to include a plurality of sensor elements 68a, which notably may also be located at different positions relative to optical damping element 26a. Detection unit 40a is furnished preferably to monitor a performance of optical damping element 26a as a function of the detection of the reflected portion of the laser beams guided through optical damping element 26a. In particular, detection unit 40a is equipped to identify an absence of a reflected portion of laser beams, especially upon or after an exit of a laser beam from optical damping element 26a. Detection unit 40a is equipped particularly to detect a malfunction and/or damage of optical damping element 26a if, upon or after emission of a laser beam through optical damping element 26a, an absence of a reflected portion of the laser beam is identified.

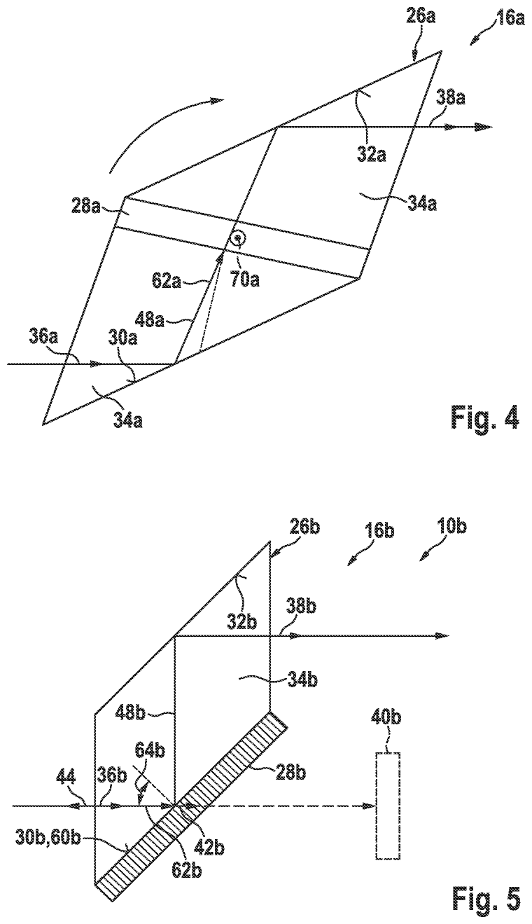

FIG. 4 shows an alternative layout of optical damping element 26a for guiding and reducing the intensity of a laser beam. A direction of intended entry vector 36a and of intended exit vector 38a remains the same, regardless of a rotation of optical damping element 26a about an axis of rotation 70a of optical damping element 26a aligned perpendicular to intended beam path 48a. This is made possible by the at least essentially parallel alignment of the two beam-guidance surfaces 30a, 32a relative to each other. In this manner, an offset of intended exit vector 38a relative to intended entry vector 36a may be altered and/or adjusted specifically via a rotation of optical damping element 26a about the/an axis of rotation 70a. In particular, an exemplary layout of optical damping element 26a is shown in FIG. 4. Other layouts of optical damping element 26a are also possible, especially with a different angle of rotation about axis of rotation 70a relative to the alignment shown in FIG. 3, in particular, entry vector 36a and exit vector 38a being aligned essentially parallel to each other with a different offset.

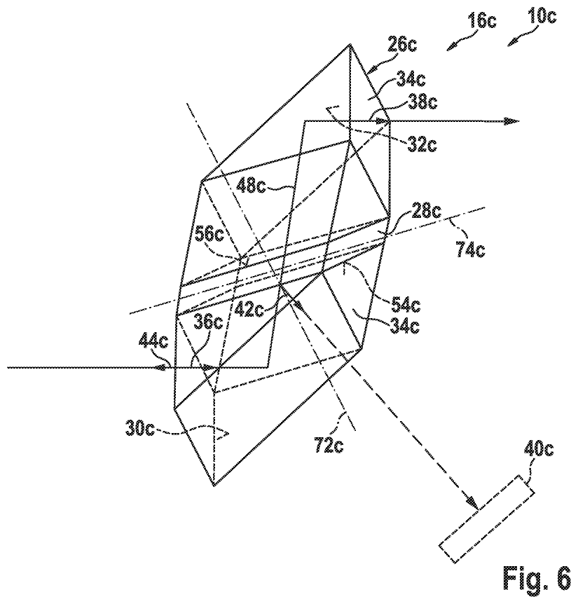

FIGS. 5 and 6 show two further exemplary embodiments of the present invention. The following descriptions and the figures are limited essentially to the differences between the exemplary embodiments; in general, one may also refer to the figures and/or the description of the other exemplary embodiments, particularly the exemplary embodiment described in FIGS. 1 through 4, with respect to identically denoted components, especially with regard to components having the same reference numerals. To differentiate the exemplary embodiments, the letter a is placed after the reference numerals of the exemplary embodiment in FIGS. 1 through 4. In the exemplary embodiments of FIGS. 5 and 6, the letter a is replaced by the letters b and c.

FIG. 5 shows a schematic side view of an optical damping element 26b of an alternative design of a microelectro-optical beam-guidance device 16b. Microelectro-optical beam-guidance device 16b is provided preferably for use in smart glasses 10b, but is not intended to be limited to that. Optical damping element 26b includes an optical filter 28b, which particularly takes the form of a neutral-density filter, a base body 34b and two beam-guidance surfaces 30b, 32b. Optical filter 28b is provided to reduce an intensity of a laser beam, especially independently of wavelength, when passing through optical damping element 26b. The two beam-guidance surfaces 30b, 32b are disposed and/or formed in such a way that an intended entry vector 36b of a laser beam into optical damping element 26b and an intended exit vector 38b of the laser beam out of optical damping element 26b are offset relative to each other as viewed along intended entry vector 36b. The two beam-guidance surfaces 30b, 32b and optical filter 28b are disposed and/or formed in such a way that portions of a laser beam propagating particularly along an intended beam path 48b and reflected at optical filter 28b within optical damping element 26b have a reflection vector 42b upon exiting optical damping element 26b which is different from a vector 44b antiparallel to intended entry vector 36b. Microelectro-optical beam-guidance device 16b shown in FIG. 5 is similar to microelectro-optical beam-guidance device 16a shown in FIGS. 1 through 4, reference being made namely to the description of FIGS. 1 through 4 with respect to identical components. Microelectro-optical beam-guidance device 16b shown in FIG. 5 differs from microelectro-optical beam-guidance device 16a shown in FIGS. 1 through 4 essentially in that optical filter 28b of microelectro-optical beam-guidance device 16b shown in FIG. 5 is disposed on one of the two beam-guidance surfaces 30b, 32b. Optical filter 28b is disposed on first beam-guidance surface 30b of the two beam-guidance surfaces 30b, 32b, as viewed along intended beam path 48b. It is also possible for optical filter 28b to be disposed on second beam-guidance surface 32b of the two beam-guidance surfaces 30b, 32b, as viewed along intended beam path 48b. Optical filter 28b and first beam-guidance surface 30b are formed in one piece, in particular laser beams being damped and/or an intensity of the laser beams being reduced in the event of an at least partial reflection occurring especially at least to a great extent at beam-guidance surface 30b. The two beam-guidance surfaces 30b, 32b are formed at least essentially parallel to one another. A surface 60b of optical filter 28b facing base body 34b of optical damping element 26b is formed in one piece with beam-guidance surface 30b. Intended beam path 48b touches optical filter 28b at surface 60b. Alternatively, it is possible for intended beam path 48b to extend at least partially into optical filter 28b, preferably in front of a kink which is assigned to a reflection of light beams at beam-guidance surface 30b. In particular, it is possible that a portion of the laser beams is transmitted through optical filter 28b. Beam-guidance device 16b preferably includes a detection unit (not shown in FIG. 5, see FIGS. 1 through 4) and/or absorption elements for the absorption of light escaping from optical damping element 26b outside of intended beam path 48b.

FIG. 6 shows a perspective view of an optical damping element 26c of a further alternative design of a microelectro-optical beam-guidance device 16c. Microelectro-optical beam-guidance device 16c is provided preferably for use in smart glasses 10b, but is not intended to be limited to that. Optical damping element 26c includes an optical filter 28c which in particular takes the form of a neutral-density filter, two base bodies 34c and two beam-guidance surfaces 30c, 32c. Optical filter 28c is provided to reduce an intensity of a laser beam, especially independently of wavelength, when passing through optical damping element 26c. The two beam-guidance surfaces 30c, 32c are disposed and/or formed in such a way that an intended entry vector 36c of a laser beam into optical damping element 26c and an intended exit vector 38c of the laser beam out of optical damping element 26c are offset relative to each other as viewed along intended entry vector 36c. The two beam-guidance surfaces 30c, 32c and optical filter 28c are disposed and/or formed in such a way that portions of a laser beam propagating particularly along an intended beam path 48c and reflected at optical filter 28c within optical damping element 26c have a reflection vector 42c upon exiting optical damping element 26c which is different from a vector 44c antiparallel to intended entry vector 36c. Microelectro-optical beam-guidance device 16c shown in FIG. 6 is similar to microelectro-optical beam-guidance device 16a shown in FIGS. 1 through 4, reference being made namely to the description of FIGS. 1 through 4 with respect to identical components. Microelectro-optical beam-guidance device 16c shown in FIG. 6 differs from microelectro-optical beam-guidance device 16a shown in FIGS. 1 through 4 essentially in that optical filter 28c of beam-guidance device 16c shown in FIG. 6 has two transmission surfaces 54c, 56c which are inclined about two imaginary axes 72c, 74c relative to the two beam-guidance surfaces 30c, 32c. The two beam-guidance surfaces 30c, 32c are aligned at least essentially parallel to one another. Transmission surfaces 54c, 56c of optical filter 28c are each inclined about the two, especially imaginary, axes 72c, 74c relative to the two beam-guidance surfaces 30c, 32c, in each case through an angle other than 0° and 90°, preferably an angle between 5° and 85°. Alternatively, it is possible for transmission surfaces 54c, 56c of optical filter 28c to be inclined about only one, especially imaginary, axis relative to at least one beam-guidance surface 30c, 32c of the at least two beam-guidance surfaces 30c, 32c, especially relative to the two beam-guidance surfaces 30c, 32c aligned at least essentially parallel to one another. Particularly first transmission surface 54c of optical filter 28c, inclined about the two axes 72c, 74c relative to beam-guidance surfaces 30c, 32c, is aligned at least essentially parallel to the other of the two, especially imaginary, axes 72c, 74c. Preferably, transmission surfaces 54c, 56c of optical filter 28c inclined about the two axes 72c, 74c relative to beam-guidance surfaces 30c, 32c are aligned at least essentially parallel to the other of the two, especially imaginary, axes 72c, 74c. In particular, the two imaginary axes 72c, 74c are aligned essentially perpendicular to each other. In particular, each of the two transmission surfaces 54c, 56c is formed as a surface of optical filter 28c. Optical filter 28c, particularly a first transmission surface 54c of optical filter 28c inclined about the two axes 72c, 74c relative to beam-guidance surfaces 30c, 32c is provided preferably to reflect portions of laser beams passing along intended beam path 48c and reflected at first transmission surface 54c, into a direction which in particular is inclined relative to a plane including intended beam path 48c. In this manner, disturbing scattered light in the area of a laser source 18c and in the area of a projection surface, e.g., at an eye of a user of smart glasses 10c, may be prevented in an advantageously easy manner. In particular, in FIG. 6, a large portion of the laser light reflected at optical filter 28c is represented as an arrow which includes reflection vector 42c.

What is claimed is:

1. A microelectro-optical beam-guidance device, comprising:
at least one optical damping element which includes at least one optical filter and at least two beam-guidance surfaces, the optical filter being provided to reduce an intensity of a light beam passing through the optical damping element, the at least two beam-guidance surfaces being disposed and/or formed in such a way that an intended entry vector of the light beam into the optical damping element and an intended exit vector of the light beam out of the optical damping element are offset relative to each other as viewed along the intended entry vector, wherein the at least two beam-guidance surfaces and the optical filter are disposed and/or formed in such a way that portions of the light beam reflected at the optical filter within the optical damping element have a reflection vector upon exiting the optical damping element which is different from a vector antiparallel to the intended entry vector.

2. The microelectro-optical beam-guidance device as recited in claim 1, wherein the optical filter reduces the intensity of the light beam independently of wavelength.

3. The microelectro-optical beam-guidance device as recited in claim 1, wherein the light beam is a laser beam.

4. The microelectro-optical beam-guidance device as recited in claim 1, wherein the at least two beam-guidance surfaces are each at least essentially flat and are aligned at least essentially parallel to one another.

5. The microelectro-optical beam-guidance device as recited in claim 1, wherein the light beam passing through the optical damping element on an intended beam path has a propagation vector at one point of a surface of the optical filter at which the light beam strikes the optical filter, the optical filter and/or the at least two beam-guidance surfaces being disposed and/or formed in such a way that the propagation vector is inclined relative to a surface normal of the surface of the optical filter.

6. The microelectro-optical beam-guidance device as recited in claim 1, wherein the at least two beam-guidance surfaces and the optical filter are disposed and/or formed in such a way that the intended entry vector and the intended exit vector are at least essentially parallel to one another.

7. The microelectro-optical beam-guidance device as recited in claim 1, wherein the optical filter has at least one surface which is inclined about two axes relative to at least one beam-guidance surface of the at least two beam-guidance surfaces.

8. The microelectro-optical beam-guidance device as recited in claim 1, wherein the optical filter is disposed at least partially between the at least two beam-guidance surfaces as viewed along an intended beam path for the light beam through the optical damping element.

9. The microelectro-optical beam-guidance device as recited in claim 1, wherein the optical filter is disposed at least partially on at least one of the at least two beam-guidance surfaces.

10. The microelectro-optical beam-guidance device as recited in claim 1, wherein the at least two beam-guidance surfaces and the optical filter are disposed and/or formed in such a way that the reflection vector and the vector antiparallel to the intended entry vector span an angle of at least 20°.

11. The microelectro-optical beam-guidance device as recited in claim 1, further comprising at least one detection unit configured to detect a portion of the light beam reflected within the optical damping element at the optical filter.

12. Smart glasses comprising at least one microelectro-optical beam-guidance device, each of the at least one microelectro-optical beam-guidance device including:
at least one optical damping element which includes at least one optical filter and at least two beam-guidance surfaces, the optical filter being provided to reduce an intensity of a light beam passing through the optical damping element, the at least two beam-guidance surfaces being disposed and/or formed in such a way that an intended entry vector of the light beam into the optical damping element and an intended exit vector of the light beam out of the optical damping element are offset relative to each other as viewed along the intended entry vector, wherein the at least two beam-guidance surfaces and the optical filter are disposed and/or formed in such a way that portions of the light beam reflected at the optical filter within the optical damping element have a reflection vector upon exiting the optical damping element which is different from a vector antiparallel to the intended entry vector.
